(19) United States
(12) Patent Application Publication
(10) Pub. No.: US 2020/0205438 A1
(43) Pub. Date: Jul. 2, 2020

(54) Method For Producing Chocolate Crumbs For Calorie Reduced Chocolate, Method For Producing Such Chocolate, And Chocolate Produced By This Method

(71) Applicant: LIMITED LIABILITY COMPANY "LIGHTHOUSE OCEAN", St. Petersburg (RU)

(72) Inventors: Artem Olegovich GORBUNOV, Ozersk (RU); Elena Viktorovna GUS'KOVA, St. Petersburg (RU); Ekaterina Vladimirovna SHREINER, St. Petersburg (RU)

(21) Appl. No.: 16/728,205

(22) Filed: Dec. 27, 2019

(30) Foreign Application Priority Data
Dec. 27, 2018 (RU) 2018147033

(51) Int. Cl. A23G 1/40; A23G 1/46; A23G 1/00

(52) U.S. Cl. CPC A23G 1/40; A23V 2002/00; A23G 1/0036; A23G 1/46

(57) ABSTRACT

The method for preparing crumb used for producing chocolate comprises combining milk products, water and a mixture of sugar alcohols and edible fibers in a mixer, then heating the prepared mass to 60-80° C. at a pressure from 20 to 30 kPa for 60 minutes, holding for 15 minutes, cooling the prepared mass down to 60° C., drying at a pressure from 20 to 25 kPa and temperature of 60° C. for 30-35 minutes for achieving a moisture content from 0.5% to 5% wt %, and cooling for 60 minutes. The method for producing chocolate comprises mixing crumb and at least one component: cocoa products, butterfat, nut paste and filling fat, refining the produced mass, conching with the addition of at least one cocoa product and at least one emulsifier, tempering the produced mass, pouring the producing mass into molds. The composition of chocolate.

### CROSS-REFERENCE TO RELATED APPLICATION

This application claims the benefit and priority of Russian Federation Application No. 2018147033 filed Dec. 27, 2018. The entire disclosure of the above application is incorporated herein by reference.

### FIELD

The invention relates to the food industry, in particular to the production of confectionery, such as white, dark, milk, filled chocolate, etc. This invention further relates to a method for preparing chocolate crumb as a base for producing chocolate.

### BACKGROUND

This section provides background information related to the present disclosure which is not necessarily prior art.

Conventional chocolate products based on cocoa butter and sugar have an energy value ranging from 530 to 580 kcal/100 g. These products are not suitable for persons suffering from diabetes mellitus and those on a low calorie diet.

Various attempts have been made to reduce an energy value of chocolate products by replacing sugar with sugar substitutes of lower energy value.

A widespread method for producing chocolate includes mixing cocoa products, sugars and milk powder (in case of producing milk chocolate), followed by refining, conching, tempering and pouring a finished product into molds.

Also, methods for producing chocolate may include condensing and drying liquid milk with sugar with or without cocoa products under vacuum at elevated temperatures for preparing chocolate crumb that is further processed according to a technological process to produce a chocolate product.

The use of chocolate crumb for producing chocolate is widely known. The main advantages of this product may include a unique caramelized flavor, a long shelf life, as opposed to milk powder, simplified steps of chocolate production, shortened period of conching, etc. US patent application 2011293781 provides a method for producing a chocolate crumb that comprises combining milk solids, water, sugar and an alpha-dicarbonyl component to add caramel flavor to the product. The sugar used in this combination should, preferably, comprise sucrose. If necessary, the sucrose may be replaced in whole or, more preferably, in part with other sugars, such as fructose, glucose, lactose, or with a reduced or non-caloric sugar substitute, such as aspartame, sucralose, monatin, steviosides, or polyols, such as erythritol, maltitol, sorbitol, or polydextrose.

European patent EP 0940085 discloses a method for preparation of chocolate crumb containing low fat milk solids, sugar or a sugar substitute, wherein the ratio of milk solids to sugar is between 1-1.5:1-0.1. The sugar in this method may be sucrose, glucose, dextrose, lactose, fructose, invert sugar, corn syrup solids, or a sugar replacer, such as sorbitol, mannitol, xylitol, maltitol, lactitol, polydextrose, etc., or mixtures thereof.

RF patent RU 2628499 discloses a fat-based premix for a confectionary product, comprising confectionary components and including a polyol, a natural and/or artificial sweetener, a fat component, and components of non-fat dry solids. This premix may also comprise a polyol and a second component comprising a monosaccharide.

A common disadvantage of the known analogs is that the existing methods for producing chocolate with reduced energy value do not allow completely avoiding the use of sugar, and, consequently, the organoleptic and physical properties of the produced chocolate will be similar to the properties of chocolate with standard energy value based on sugar and cocoa butter.

### SUMMARY

This section provides a general summary of the disclosure, and is not a comprehensive disclosure of its full scope or all of its features.

The object of this invention is production of chocolate with reduced energy value by preliminarily preparing chocolate crumb, then refining the prepared crumb, mixing with ingredients required for producing chocolate, conching, tempering of a produced mass, and pouring the mass into a mold to obtain a finished product.

The technical effect of the claimed invention is full substitution of sugar for a mixture of polyols and edible fibers, which enables to produce chocolate with reduced energy value, improved texture and rheological properties corresponding to the standard requirements.

The additional technical effects also provided by the claimed invention are greater efficiency and shortened time period of drying chocolate crumb, and producing a stable emulsion with uniform drop size in the process of preparing chocolate crumb, which contributes to production of a product with equal size crystals, simplifying the processes of transportation, storage and processing of chocolate crumb.

These technical effects are achieved in the claimed invention due to the fact that the method for preparing chocolate crumb for preparation of chocolate with reduced energy value comprises combining milk products, water, a mixture of sugar alcohols (polyols) and edible fibers in a mixer, stirring of a mass produced and heating it up to a temperature between 60 and 80° C. for at least 60 minutes at a reduced pressure between 20-30 kPa, holding this mass for at least 15 minutes in order to transform the mass from the pasty to powdery state, cooling down to 60° C. and drying at a pressure between 20 and 25 kPa and a temperature of 60° C. for 30-35 minutes until the moisture content is from 0.5 to 5 wt %, and then cooling the mass by introducing cold water into the jacket of the mixer used for combining the above components for 60 minutes.

A cocoa product may be used as an additional component for preparing chocolate crumb.

At least one substance selected from polydextrose, inulin, fructooligosaccharides, fructans, maltodextrin and similar polymers of glucose, glucose fiber, pectin, carrageenan, agar, gums, e.g. guar, glucomannan, etc., microcrystalline cellulose may be used as the edible fibers.

At least one substance of erythritol, maltitol, sorbitol, isomalt, lactitol may be used as the sugar alcohol.

At least one of non-fat dry milk, whole milk, whole milk powder, concentrated milk with fat content from 8 to 10% may be used as the milk products.

At least one of cocoa butter, ground cocoa, cocoa powder or a combination thereof may be used as the cocoa products.

The claimed invention also enables to eliminate the drawbacks of chocolate crump comprising only sugar substitutes (polyols) as a sweetness producing component, such as a strong cooling effect in the mouth cavity, low sweetness of a product due to the fact that relative sweetness of polyols is from app. 40% to 70% of the total sucrose sweetness, a laxative effect.

The use of a combination of polyols and edible fibers enables to balance these drawbacks. For example, an exothermic effect arising during dissolution of edible fibers in the process of preparing chocolate crumb enables to partially neutralize a cooling effect arising during dissolution of sugar alcohols. Furthermore, the use of edible fibers in confectionary enables to manufacture a product with improved texture, flavor quality and greater sweetness. At the same time, edible fibers have a prebiotic effect, which raises a physiological value of a product.

One more important advantage of edible fibers is the capacity of some of them to enter into Maillard reactions that are the basis for forming flavor and aroma of chocolate crumb. The conditions required for carrying out this reaction are presence of a sufficient quantity of moisture in a reaction mass, reaction temperature and time period as well as presence of reducing sugars and protein in the reaction mass.

Thus, depending on an edible fiber selected for preparing chocolate crumb, milk chocolate with pronounced caramel flavor or caramelized white chocolate may be produced. If necessary, an edible fiber may be selected that does not cause a Maillard reaction (e.g., Litesse Ultra polydextrose), so white or dark chocolate may be produced from this chocolate crumb.

The term “chocolate with reduced energy value” or “calorie reduced chocolate” refers to a product having an energy value at least 30% less than that of standard calorie chocolate (530-580 kcal/100 g) based on sugar and cocoa butter (see: Annex 5 to the Technical Regulations of the Customs Union “Food Products in Terms of Their Labeling (TR TU 022/2011)”). Preferably, an energy value of chocolate according to the invention is not greater than 240-400 kcal/100 g.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BEST MODE OF CARRYING OUT THE INVENTION

The chocolate with reduced energy value according to the claimed invention may be produced as follows.

The first stage is preparation of chocolate crumb.

A device that may be used for preparing chocolate crumb is a mixer with horizontal or vertical stirring or a screw-type mixer. The mixer may be provided with a water jacket, a thermostatic sensor, a fan, a vacuum system as well as with a stirrer with blades; a size of stirrer blades, their number, arrangement, geometric shape and rotation speed should ensure continuous stirring of the components (ingredients) without forming “dead spots”.

In order to achieve efficient stirring, a mixer with 3 to 10 blades is used. A stirrer rotation speed is up to 1,500 rpm.

The vacuum system in the mixer ensures quick and efficient removal of moisture from a mixture at low temperatures.

In order to produce chocolate crumb, the components (or ingredients) including a milk product, sugar alcohols, edible fibers and, if necessary, cocoa products are fed into a mixer. The components for preparing chocolate crumb are taken, preferably, in the following quantities, in wt %:

Milk component—6-80,

Water—0,5-40,

Sugar alcohols—6-70,

Edible fibers—3-45,

Cocoa products—0-40.

Then, the components are mixed, and the obtained mixture is heated to a temperature between 60° C. and 70° C. at a low pressure between 20 and 30 kPa for 60 minutes. When the required temperature is achieved, it is maintained for at least 15 minutes for imparting required flavor and aroma properties and direct drying of the produced mass for removing moisture to a value between 0.5 and 5 wt %. The drying is carried out at a reduced pressure between 20 and 25 kPa and temperature of 60° C. for 30-35 minutes. The produced mass is cooled by introducing cold water into the mixer jacket for 60 minutes.

At the second stage, the produced chocolate crumb is supplemented with cocoa products in the quantity of 0.5-40 wt % and, if necessary, with butterfat in the quantity of 0.1-5 wt %.

At the next, third stage, the produced mass is subjected to two-stage refinement in a double roller mill to form particles with a size of 100-130 microns, then in a five-roller mill to form particles with a size of 20-26 microns, or, alternatively, to one-stage refinement in any suitable equipment, e.g. a roll ball mill, to form particles with a size of 20-24 microns.

At the fourth stage, the produced mass is conched, and at least one cocoa product is added in a quantity from 0.5 to 15% which product is selected from the group comprising: cocoa butter, ground cocoa, cocoa powder, or a combination thereof, and at least one emulsifier in a quantity from 0.2 to 1% that is selected from the group comprising: lecithines, PGPR, sorbitan tristearate, ammonium phosphatides.

At the final stage, the produced mass is tempered, then poured into molds and formed as the finished product.

In a case of producing chocolate with a fat filling, the latter is prepared by adding cocoa butter, nut paste and filling fat to the produced chocolate crumb. The final stage in the case of producing chocolate with a fat filling also comprises tempering the produced filling mass, then pouring into mold for obtaining chocolate shell to produce stuffed bars or chocolate sweets.

### DRAWINGS

The drawings described herein are for illustrative purposes only of selected embodiments and not all possible implementations, and are not intended to limit the scope of the present disclosure.

FIG. 1 illustrates a dependence of moisture content change in milk chocolate crumb in time.

FIG. 2 illustrates a drying process for (a) chocolate crumb comprising sucrose and (b) chocolate crumb comprising a mixture of polyols and edible fibers.

FIG. 3 illustrates a particle size distribution.

FIG. 4 illustrates dependency examples after measuring plastic viscosity at different spindle rotation rates, as obtained with the use of Brookfield DV3 rotary viscometer, and processing of obtained data with the use of the Casson mathematic model. The curve a characterizes apparent viscosity change in time, the curve b characterizes yield stress change in time.

FIG. 5 illustrates sensory profiles for chocolate produced with the use of milk chocolate crumb comprising sucrose; milk chocolate crumb comprising polyols; and milk chocolate crumb comprising a mixture of polyols and edible fibers.

### DETAILED DESCRIPTION

Example embodiments will now be described more fully with reference to the accompany drawings.

Chocolate crumb was prepared in accordance with the invention for producing white chocolate (Example 1), milk chocolate (Example 2), dark chocolate (Example 3) and filled chocolate (Example 4).

### Example 1. Production of White Chocolate

In order to prepare chocolate crumb for subsequent production of white chocolate, milk powder or concentrated milk was used. The composition and the ingredients for the preparation of crumb are shown in Tables 1 and 2.

TABLE 1
Composition of a chocolate crumb mixture for producing
white chocolate with the use of milk powder.

| | | Content, | Content, |
|---|---|---|---|
| Ingredient | Functional property | minimum % | maximum, % |
| Water | | 20 | 40 |
| Milk powder | Milk product | 6 | 38 |
| Erythritol | Sugar alcohols | 20 | 69 |
| Polydextrose | Edible fibers | 6 | 38 |

TABLE 2
Composition of a chocolate crumb mixture for producing
white chocolate with the use of whole milk.

| | | Content, | Content, |
|---|---|---|---|
| Ingredient | Functional property | minimum, % | maximum, % |
| Concentrated milk | Milk product | 30 | 80 |
| Erythritol | Sugar alcohols | 20 | 69 |
| Polydextrose | Edible fibers | 6 | 38 |

After the crumb drying stage is finished, concentrated milk crumb has the composition given in Table 3.

TABLE 3
Composition of chocolate crumb after drying process

| | | Content, | Content, |
|---|---|---|---|
| Ingredient | Functional property | minimum, % | maximum, % |
| Water | | 0.5 | 5 |
| Erythritol | Sugar alcohols | 10 | 55 |
| Polydextrose | Edible fibers | 12 | 30 |
| Milk powder | Milk products | 10 | 30 |

The composition and quantity of the components for producing white chocolate mass are indicated in Table 4.

TABLE 4
Composition of white chocolate mass.

| Ingredient | Content, minimum, % | Content, maximum, % |
|---|---|---|
| Milk crumb | 65 | 84 |
| Cocoa butter | 15 | 30 |
| Butterfat | 1 | 5 |
| Emulsifiers | 0.2 | 1.5 |

The finished product is characterized by the physical and chemical parameters given in Table 5.

TABLE 5
Physical and chemical parameters of white chocolate.

| Parameter | Value |
|---|---|
| Butterfat, % | 3.5-7 |
| Total fat residual solids, % | 20-35 |
| Moisture, % | 0.5-5 |
| Energy value, kcal/100 g | 240-400 |

The fat content was determined according to an extraction and weighting method.

The content of cocoa product residual solids was determined by a method of calculating a total percent content of cocoa residual solids in each of cocoa-containing ingredients in accordance with its quantity in the final formulation of the finished product.

The energy value of chocolate mass was determined by summing up the energy values of each ingredient, with due regard to its quantity in the final formulation of the finished product.

### Example 2. Production of Milk Chocolate

In order to prepare chocolate crumb for subsequent production of milk chocolate, milk powder or concentrated milk was used. The composition and the ingredients for the preparation of crumb are shown in Tables 6 and 7.

TABLE 6
Composition of a chocolate crumb mixture for producing
milk chocolate with the use of milk powder.

| | | Content, | Content, |
|---|---|---|---|
| Ingredient | Functional property | minimum, % | maximum, % |
| Water | | 20 | 40 |
| Milk powder | Milk product | 9 | 57 |
| Erythritol | Sugar alcohols | 6 | 69 |
| Polydextrose | Edible fibers | 3 | 45 |
| Ground | Cocoa products | 6 | 38 |
| cocoa | | | |

TABLE 7
Composition of a chocolate crumb mixture for producing
milk chocolate with the use of whole milk.

| | | Content, | Content, |
|---|---|---|---|
| Ingredient | Functional property | minimum, % | maximum, % |
| Whole | Milk product | 25 | 80 |
| concentrated milk | | | |
| Erythritol | Sugar alcohols | 6 | 69 |
| Polydextrose | Edible fibers | 3 | 45 |
| Ground | Cocoa products | 6 | 38 |
| cocoa | | | |

If necessary, a mixture of cocoa butter and cocoa solids in the ratio from 0.8:1.2 to 1.2:0.8 may be used instead of ground cocoa.

After the crumb drying stage is finished, concentrated chocolate crumb has the composition given in Table 8.

TABLE 8
Composition of chocolate crumb for producing
milk chocolate after drying process.

| | | Content, | Content, |
|---|---|---|---|
| Ingredient | Functional property | minimum, % | maximum, % |
| Water | | 0.5 | 5 |
| Erythritol | Sugar alcohols | 10 | 55 |
| Polydextrose | Edible fibers | 5 | 35 |
| Ground cocoa | Cocoa products | 10 | 30 |
| Milk powder | Milk products | 15 | 45 |

The composition and quantity of the components for producing chocolate mass of milk chocolate are indicated in Table 9.

TABLE 9
Composition of milk chocolate mass.

| Ingredient | Content, minimum, % | Content, maximum, % |
|---|---|---|
| Chocolate crumb | 65 | 80 |
| Ground cocoa | 2 | 10 |
| Cocoa butter | 10 | 20 |
| Butterfat | 1 | 5 |
| Emulsifiers | 0.2 | 1.5 |

The finished product is characterized by the physical and chemical parameters given in Table 10.

TABLE 10
Physical and chemical parameters of milk chocolate.

| Parameter | Value |
|---|---|
| Residual solids of cocoa products, % | 25-65 |
| Total fat residual solids, % | 20-35 |
| Residual solids of milk products, % | 12-25 |
| Moisture, % | 0.5-5 |
| Energy value, kcal/100 g | 250-400 |

The fat content, residual solids of cocoa products and milk products and the energy value of chocolate mass were determined my methods similar to those described in Example 1.

### Example 3. Production of Dark Chocolate

The composition and quantity of the components for preparing chocolate crumb for dark chocolate are indicated in Table 11.

TABLE 11
Composition of a mixture for preparing
chocolate crumb for dark chocolate.

| | | Content, | Content, |
|---|---|---|---|
| Ingredient | Functional property | minimum, % | maximum, % |
| Water | | 20 | 40 |
| Erythritol | Sugar alcohols | 9 | 36 |
| Polydextrose | Edible fibers | 3 | 28 |
| Ground cocoa | Cocoa products | 7 | 32 |

After the crumb drying stage is finished, concentrated chocolate crumb has the composition given in Table 12.

TABLE 12
Composition of the semi-finished product after the drying process.

| | | Content, | Content, |
|---|---|---|---|
| Ingredient | Functional property | minimum, % | maximum, % |
| Water | | 0.5 | 5 |
| Erythritol | Sugar alcohols | 15 | 45 |
| Polydextrose | Edible fibers | 5 | 35 |
| Ground cocoa | Cocoa products | 10 | 40 |

The composition and quantity of the components for producing chocolate mass for dark chocolate are indicated in Table 13.

TABLE 13
Composition of dark chocolate mass.

| Ingredient | Content, minimum, % | Content, maximum, % |
|---|---|---|
| Chocolate crumb | 60 | 89 |
| Cocoa butter | 5 | 20 |
| Emulsifiers | 0.2 | 1.5 |
| Ground cocoa | 5 | 20 |

The finished product is characterized by the physical and chemical parameters given in Table 14.

TABLE 14
Physical and chemical parameters of dark chocolate.

| Parameter | Value |
|---|---|
| Residual solids of cocoa products, % | 35-65 |
| Total fat residual solids, % | 20-35 |
| Moisture, % | 0.5-5 |
| Energy value, kcal/100 Γ | 260-390 |

The fat content, the content of residual solids of cocoa products and milk products and the energy value of chocolate mass were determined my methods similar to those described in Example 1.

### Example 4. Production of Chocolate with Fat Filling

The composition and quantity of the ingredients for preparing chocolate crumb for subsequent production of chocolate with fat filling are shown in Tables 15 and 16.

TABLE 15
Composition of a mixture for preparing chocolate crumb for producing
chocolate with a fat filling with the use of milk powder.

| | | Content, | Content, |
|---|---|---|---|
| Ingredient | Functional property | minimum, % | maximum, % |
| Water | | 20 | 40 |
| Milk powder | Milk product | 9 | 57 |
| Erythritol | Sugar alcohols | 6 | 69 |
| Polydextrose | Edible fibers | 3 | 45 |
| Cocoa solids | Cocoa products | 3 | 18 |

TABLE 16
Composition of a mixture for preparing chocolate crumb for producing
chocolate with a fat filling with the use of whole milk.

| | | Content, | Content, |
|---|---|---|---|
| Ingredient | Functional property | minimum, % | maximum, % |
| Whole milk | Milk product | 25 | 80 |
| Erythritol | Sugar alcohols | 6 | 69 |
| Polydextrose | Edible fibers | 3 | 45 |
| Cocoa solids | Cocoa products | 3 | 18 |

After the drying stage is finished, concentrated chocolate crumb has the composition given in Table 17.

TABLE 17
Composition of chocolate crumb after the drying process.

| | | Content, | Content, |
|---|---|---|---|
| Ingredient | Functional property | minimum, % | maximum, % |
| Water | | 0.5 | 5 |
| Erythritol | Sugar alcohols | 10 | 55 |
| Polydextrose | Edible fibers | 5 | 35 |
| Cocoa solids | Cocoa products | 5 | 15 |
| Milk powder | Milk products | 15 | 45 |

TABLE 18
Composition of the fat filling.

| Ingredient | Content, minimum, % | Content, maximum, % |
|---|---|---|
| Chocolate crumb | 50 | 75 |
| Nut paste | 10 | 20 |
| Filling fat | 15 | 25 |
| Cocoa butter | 0.5 | 2 |
| Emulsifiers | 0.2 | 1.5 |

The finished product is characterized by the physical and chemical parameters given in Table 19.

TABLE 19
Physical and chemical parameters of the fat filling.

| Parameter | Value |
|---|---|
| Residual solids of cocoa products, % | 25-65 |
| Total fat residual solids, % | 25-35 |
| Moisture, % | 0.5-5 |
| Energy value, kcal/100 Γ | 250-400 |

The fat content, the content of residual solids of cocoa products and milk products and the energy value of chocolate mass were determined my methods similar to those described in Example 1.

The fact that the claimed technical effects are achieved is confirmed by Examples 5-8 described below.

Chocolate crumb samples comprising sucrose as the sweetness providing component, chocolate crumb samples comprising polyols as the sweetness providing component, and chocolate crumb samples comprising a mixture of polyols and edible fibers as the sweetness providing component were used for the tests.

### Example 5. Influence of Crumb Composition on Effectiveness of its Drying

The mixture used for preparing chocolate crumb is a concentrated direct emulsion, i.e. an emulsion of oil-in-water type. When cocoa products are added into the mixture protein of cocoa products formed in a chocolate crumb composition significantly changes the flavor of the composition, and a protein-polysaccharide complex provides additional thermodynamic stability of the system due to formation of a structural-mechanical barrier at the phase boundary, which barrier is characterized by high viscosity values. This factor influences the morphology of the drop surface, forming a more stable emulsion and thus resulting in an easier drying process, which may be confirmed by the following experiment.

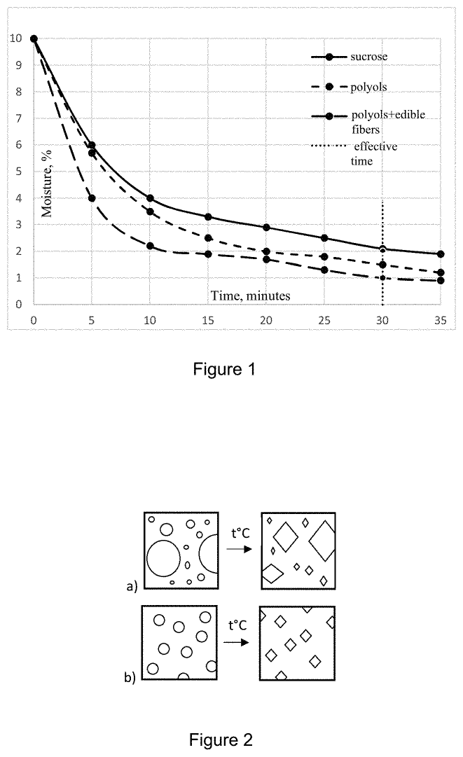

In order to confirm that the stated technical effect is achieved, an experiment was conducted wherein chocolate crumb was dried in a mixer provided with a water jacket and a thermostatic sensor at constant temperature of 60° C. for 30 minutes, chocolate crumb samples being taken every five minutes. A moisture content was determined with a moisture analyzer for each sample. The obtained dependencies of a moisture content on time are presented in FIG. 1.

It follows from the data obtained that in the same effective drying time period (30 minutes) for chocolate crumb, which composition comprises sucrose as the sweetness providing component, it was managed to achieve moisture removal to the level of 2.1% only; for chocolate crumb, which composition comprises polyols as the sweetness providing component, this value is 1.5%; and for chocolate crumb, which composition comprises a mixture of polyols and edible fibers as the sweetness providing component, this value is 1%.

On the basis of the data obtained the conclusion may be made that full replacement of sucrose by a mixture of edible fibers and sugar alcohols (polyols) results in making the drying process easier, which also enables to shorten the time period of the chocolate crumb active drying.

### Example 6. Influence of a Chocolate Crumb Composition on its Dispersibility as Well as on Shelf Life and Simplicity of Future Processing

Drop shape and size of an emulsion for preparing chocolate crumb depend on its components. Various shapes and sizes of emulsion drops at the drying stage result in that crystals formed from emulsion drops in the drying process also have various shapes and sizes. FIG. 2a schematically depicts the process of drying chocolate crumb which composition comprises sucrose as the sweetness providing component; FIG. 2b schematically shows the process of drying chocolate crumb which composition comprises a mixture of polyols and edible fibers as the sweetness providing component.

It follows from the data presented that in the case of chocolate crumb, which composition comprises sucrose as the sweetness providing component, drop sizes in the formed emulsion are non-uniform which results in forming crystals of various shapes and sizes (FIG. 2a). Meanwhile, the use of chocolate crumb, which composition comprises a mixture of polyols and edible fibers as the sweetness providing component, enables to form an emulsion with drops of equal sizes, which facilitates formation of more uniform (as to shape and size) crystals of the final product (chocolate) (FIG. 2b).

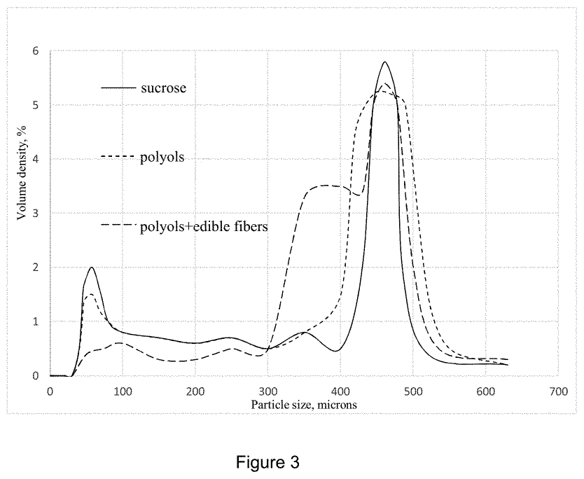

Dispersibility of chocolate crumb was determined by laser diffractometry with the use of the SALD-2300 analyzer. For this purpose, a 2 g sample was placed in a container for dispersing, the sample was delivered to the flow cell by a pump, then refracted and scattered light was determined by the sensor, and necessary measurements were taken. The obtained data were presented as particle size distribution graphs with the use of the software (FIG. 3).

FIG. 3 shows the obtained size distribution graphs for different mixtures: chocolate crumb comprising sucrose as the sweetness providing component; chocolate crumb comprising polyols as the sweetness providing component providing; and chocolate crumb comprising a mixture of polyols and edible fibers as the sweetness providing component.

It follows from FIG. 3 that in the case of the chocolate crumb comprising sucrose as the sweetness providing component the mixture mainly contains particles with a size of 400-500 microns, but a significant quantity of fine particles (dust) of 10-50 microns may be observed, which negatively affects the storage of the chocolate crumb due to agglomeration of fine particles.

When sucrose is fully replaced by a mixture of polyols and edible fibers, only large particles with a size from 300 to 500 microns are present in the mixture, which significantly facilitates not only the process of storage of chocolate crumb, but also its further processing in double roller and five-roller mills.

### Example 7. Determination of Product Rheological Properties

The determination of the rheological properties is an important and integral part of the whole technological process of preparing chocolate crumb and chocolate.

Quality characteristics of chocolate crumb depend on certain parameters, such as chocolate mass viscosity and yield stress.

If a viscosity value is selected incorrectly, it may result in manufacturing of products of improper quality, not complying with the visual and organoleptic requirements. Moreover, the use of products having viscosity values and yield stress not complying with the applicable requirements causes difficulties in the process of transporting a mass along the production line, filling tanks, dosing and molding.

It was found during the experiments that viscosity and yield stress values for low calorie dark and milk masses correspond to average values of the similar parameters for a standard mass.

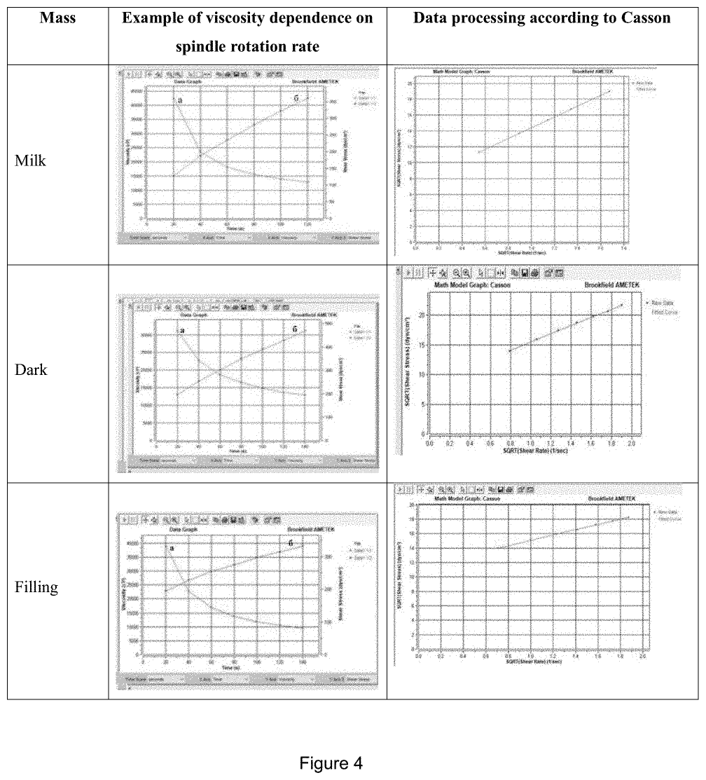

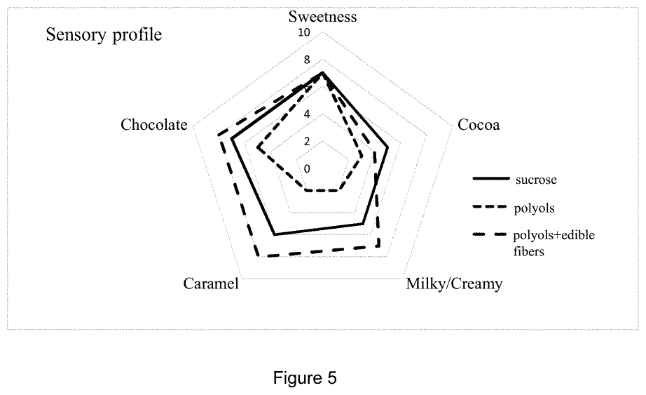

FIG. 4 shows examples of dependencies obtained after measuring plastic viscosity at various rotation speeds of the spindle with the use of a Brookfield DV3 rotary viscometer. These values were processed with the use of the most widespread mathematical model in the confectionary industry—the Casson model.

Two curves may be observed in dependencies shown in FIG. 4 that were obtained after measurements. The curve a characterizes changes in apparent viscosity in time, and the curve b—changes in yield stress in time.

Strictly speaking, the presentation of chocolate mass viscosity as a curve is inconvenient for describing chocolate delivered by a manufacturer as well as for identifying causes of production problems. An alternative method of presenting viscosity is the use of an equation describing movement of chocolate mass. One of the most widespread models used in the confectionary industry for describing motion of mass is the Casson model. This equation is graphically shown in FIG. 4b. Universal values of plastic viscosity and yield stress may be calculated with the use of a dependency of shear rate on shear stress.

As a result of processing of the data thus obtained, the following values of plastic viscosity and yield stress were derived:
for chocolate mass of dark chocolate: viscosity 5.5-7 Pa·s, yield stress 13-50 dyne/cm²;
for chocolate mass of milk chocolate: viscosity 3.9-5.2 Pa·s, yield stress 5-20 dyne/cm²;
for chocolate mass of chocolate with filling: viscosity 2.5-7 Pa·s, yield stress 50-80 dyne/cm².

The results of a comparative analysis of plastic viscosity values for milk chocolate produced on the basis of chocolate crumb comprising sucrose, chocolate crumb comprising polyols, and chocolate crumb comprising a mixture of polyols and edible fibers is presented in Table 20.

The total fat content (a sum total of the fats in the composition of each ingredient in accordance with its quantity in the final formulation of the finished product) of each sample was 27%.

TABLE 20
Plastic viscosity values of chocolate samples.

| | | | Chocolate crumb |
|---|---|---|---|
| | | | with mixture |
| Milk chocolate | Chocolate crumb | Chocolate crumb | of polyols and |
| sample | with sucrose | with polyols | edible fibers |
| Plastic | 5-7 Pa*s | 4-6 Pa*s | 3-5 Pa*s |
| viscosity value | | | |

It may be concluded on the basis of the data obtained that the full replacement of sucrose with a mixture of polyols and edible fibers and a reduction of total fat content (a sum total of all fats in the composition of each ingredient) do not result in a significant change in the chocolate crumb rheological properties in the method for producing chocolate with reduced energy value according to the claimed invention; and such mass is suitable for transporting, dosing and molding.

### Example 8. Organoleptic Characteristics of the Finished Product

In order to compare organoleptic characteristics of milk chocolate, samples of chocolate produced on the basis of milk chocolate crumb comprising sucrose as the sweetness providing component; milk chocolate crumb comprising polyols as the sweetness providing component; and milk chocolate crumb comprising a mixture of polyols and edible fibers as the sweetness providing component were used. Thirty persons participated in the taste testing. Sensory profiles were prepared on the basis of data provided by the test participants.

It follows from the data obtained from the test participants that the milk chocolate with reduced energy value produced with the use of milk crumb comprising a mixture of polyols and edible fibers as the sweetness providing component has more pronounced caramel and milk taste, as compared to the milk chocolate produced with the use of chocolate crumb comprising sucrose as the sweetness providing component and chocolate crumb comprising polyols as the sweetness providing component.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for preparing crumb used for producing chocolate with reduced energy value, comprising combining milk products, such as non-fat dried milk, whole milk, dried whole milk, concentrated milk with a fat content from 8 to 10% in a quantity from 6 to 80 wt %, water in a quantity from 0.5 to 40 wt %, a mixture of sugar alcohols in a quantity from 6 to 70 wt % and edible fibers in a quantity from 3 to 45 wt % in a mixer; heating the prepared mass to a temperature from 60 to 80° C. at a reduced pressure from 20 to 30 kPa for at least 60 minutes; holding for at least 15 minutes to ensure transformation of said mass from pasty to powdery state; cooling the prepared mass down to 60° C.; drying at a pressure from 20 to 25 kPa and temperature of 60° C. for 30-35 minutes to achieve a moisture content from 0.5% to 5% wt %; and cooling for 60 minutes.

2. The method for preparing crumb according to claim 1, characterized in that at least one substance from the group, which comprises erythritol, maltitol, sorbitol, isomalt and lactitol, is used as the sugar alcohols.

3. The method for preparing crumb according to claim 1, characterized in that at least one substance from the group, which comprises polydextrose, inulin, fructooligosaccharides, fructans, maltodextrin and similar glucose polymers, glucose fiber, pectin, carrageenan, agar, gums, such as guar gum, glucomannan and the like, and microcrystalline cellulose, is used as edible fibers.

4. A method for producing chocolate with reduced energy value, comprising: mixing crumb prepared according to the method of claim 1 and at least one component selected from cocoa products, butterfat, nut paste and filling fat; then refining the prepared mass, conching it with addition of at least one cocoa product and at least one emulsifier, tempering the prepared mass, pouring the prepared mass into molds.

5. The method for producing chocolate according to claim 4, characterized in that at least one substance, which is selected from lecithins, PGPR, sorbitan tristearate, ammonium phosphatides, or a combination thereof, is used as the emulsifier.

6. The method for producing chocolate according to claim 4, characterized in that at least one product selected from cocoa butter, ground cocoa and cocoa powder is used as said cocoa products.

7. The method for producing chocolate according to claim 4, characterized in that said components are mixed in any suitable apparatus, preferably in a screw-type mixer or a mixer with horizontal or vertical stirring.

8. The method for producing chocolate according to claim 4, characterized in that said refining is two-stage refining in double roller and/or five-roller mills or single-stage refining in any equipment suitable for this purpose.

9. A chocolate with reduced energy value produced by a method according to claim 4, which composition comprises the crumb in a quantity from 50 to 90 wt %, as prepared by the method according to claim 1, cocoa products selected from ground cocoa and/or cocoa butter in a quantity from 35 to 40 wt %, and at least one component of the following, in wt %:
butterfat—0-5,
emulsifiers—0.2-1.5.

10. Chocolate according to claim 9, characterized in that chocolate may additionally comprise fat filling which composition comprises the crumb, as prepared according to the method of claim 1, in a quantity from 50 to 75 wt %, nut paste in a quantity from 10 to 20 wt %, filling fat in a quantity from 15 to 25 wt %, cocoa butter in a quantity from 0.5 to 2 wt %, emulsifiers in a quantity from 0.2 to 1.5 wt %.
